(19) United States
(12) Patent Application Publication
(10) Pub. No.: US 2006/0087113 A1
(43) Pub. Date: Apr. 27, 2006

(54) Pre-converted roll stock for forming return envelopes and packaging

(76) Inventors: Aric N. Snyder, Sedalia, MO (US); George H. Fry, Lincoln, MO (US)

Correspondence Address: SHUGHART THOMSON & KILROY, PC, 120 WEST 12TH STREET, KANSAS CITY, MO, 64105, US

(21) Appl. No.: 11/259,529

(22) Filed: Oct. 26, 2005

Related U.S. Application Data
(60) Provisional application No. 60/622,526, filed on Oct. 27, 2004.
(60) Provisional application No. 60/715,037, filed on Sep. 8, 2005.

(51) Int. Cl. B42D 15/00

(52) U.S. Cl. 283/106

(57) ABSTRACT

Pre-converted roll stock has a continuous web with printable surfaces that include a plurality of spaced registration marks for reference in positioning converting operations and image printing. The web has been pre-converted by application of remoistenable and pressure sensitive co-adhesive compositions, scratch off coatings, perforations, scores, notches, embossing and die cuts in preselected locations to form templates on the continuous web roll for a variety of printing and packaging applications, including printed pieces with self-mailers, return envelopes, reply cards, presentation folders, boxes and CD jackets. Selected registration marks are used to align an imaging device such as a digital press for printing the pre-converted stock with personalized variable data in the form of text and images. Once printed, the roll stock may be cut and folded to form self-mailing envelopes, fliers and return envelopes, reply cards, boxes, sleeves and the like and may be subjected to additional conversion operations.

### CROSS-REFERENCE TO RELATED APPLICATION

This application claims priority under 35 U.S.C. 119(e) and 37 C.F.R. 1.78(a)(4) based upon copending U.S. Provisional Application Ser. Nos. 60/622,526 for PAPER ROLL STOCK FOR FORMING RETURN ENVELOPES, filed Oct. 27, 2004 and 60/715,037 for PAPER ROLL STOCK FOR FORMING RETURN ENVELOPES AND PACKAGING, filed Sep. 8, 2005, which applications are incorporated herein.

### BACKGROUND OF THE INVENTION

The present invention is broadly concerned with printable roll stock that is pre-print converted or “pre-converted” for subsequent printing and folding to form integrated return envelopes, postcards, packaging and the like. More particularly, it is concerned with roll stock that is “pre-converted” by the application of registration indicia, perforations, scores, die cuts, embossing, adhesives and other coatings to form printable templates or shells on the stock. The pre-converted roll stock can be stored for subsequent custom printing as needed. After printing, the roll stock is cut into sheets and can be folded to form self-mailers, return envelopes and packaging pieces.

Mailable commercial print pieces are generally configured as self-mailers and/or flyers with attached business reply or return envelopes. They include mechanically applied conversion features such as tear off or tear out portions, so-called zip strips for easy access to contents in return order envelopes, holes and windows for viewing the envelope contents, adhesive portions for forming pockets or envelopes, and coated scratch-off portions. These features require complex conversion of the paper stock by the application of adhesives, coatings, scoring, perforating, die cutting and embossing, so that the paper stock can be cut to a selected length and folded to form a self-mailer and/or return envelope incorporating such conversion features.

Commercial packaging pieces are generally configured to be printed and then folded to form a box, sleeve or folder. Although they are not always intended to be used for mailing, packaging pieces typically include the same types of conversion features as mailable commercial print pieces. Such conversion enables folding and gluing of the printed stock into three dimensional containers for receiving various kinds of products while incorporating such conversion features to enable viewing and easy access.

Conventional production of converted commercial print and packaging pieces involves first printing the roll or sheet stock on a press or printer and then converting the roll or sheet stock by embossing, applying adhesives, perforations, die cuts and the like. Examples of prior art references that teach printing of roll stock followed by conversion include U.S. Pat. No. 4,031,818 (Kehoe); U.S. Pat. No. 4,997,504 (Wood); U.S. Pat. No. 5,041,072 (McClelland); and U.S. Pat. No. 5,803,889 (Littman).

Sheet stock or blanks may also be printed followed by conversion, as shown In U.S. Pat. No. 4,731,048 (Marella et al.); U.S. Pat. No. 4,411,643 (Higginson); U.S. Pat. No. 4,443,211 (Wooley); U.S. Pat. No. 5,290,225 (Younger); U.S. Pat. No. 5,370,304 (Sauerwine et al.); 6and U.S. Pat. No. 5,779,612 (Whitney).

FIG. 1 depicts an exemplary conventional system for production of commercial print pieces in which rollstock is printed and post-press converted or “post-converted”. A roll of printable stock A is mounted on a roll stand for unrolling and feeding into a printer B. The stock bearing printed images C proceeds through a series of converting stations D (only one is shown) where it is converted by mechanical application of glues, perforations E, die cuts and scores to form a template around the printed image C. While FIG. 1 depicts a single conversion station at perforator D, the conventional conversion process typically employs a number of conversion stations. The equipment at each conversion station D must be set up and calibrated to apply one or more adhesive patterns, perforations, scoring, embossing, die cutting and coatings in a preselected arrangement that is sited on the surface(s) of the stock using the printed image to form a template around the preprinted images for subsequent cutting and folding operations to form a piece having, for example, a return envelope pouch, window and zip strip access with appropriately positioned printed images and/or text. The printed, converted stock is then passed through a cutting apparatus F, such as a guillotine cutter, where the stock is cut into sheets for binding (if applicable) and finishing. The printed, cut stock may also be passed through a folder, for example, for folding into a self-mailer format.

Since a plurality of conversion stations D is generally employed, each piece of conversion equipment must be coordinated to function with the others, so that each sequential operation cooperates to form an overall template that is in registry with the pre-printed text and images on the stock. Any failure of alignment, coordination of the conversion equipment, operator and/or equipment error may result in misregistry of the conversion template with the printed text and/or images, so that they are spoiled by perforations, cuts, folds, glue or coatings occurring at incorrect locations. Such prior art equipment calibration and post-conversion of the printed pieces is relatively time consuming, and large print orders typically require a matter of weeks to accomplish post-converting of the printed stock into finished pieces.

Because of the speed and complexity of the conversion operations, there is substantial spoilage of the printed stock when any of the conversion processes fails to properly align with the printed images, or when there is operator or equipment error. Such spoilage may constitute as much as 25%, depending on the complexity of the post-print conversion process. Traditional roll-printing methods applied a repeating series of identical images and/or text. In traditional post-print production runs it is possible to compensate for this wastage by printing additional images on the stock, known as “overruns” to be used for readjustment of the equipment in order to complete the job order. However, the production lead time associated with this lengthy setup process and the cost of print overruns serve to make such post-press converted marketing and packaging pieces time and cost-prohibitive for all but large volume orders. Certain marketers perceive this as an insurmountable barrier and typically limit their mailings to simple, static, non-personalized pieces such as flyers that do not include personalized variable data on self mailers or return envelopes, so that they do not incur the expense and production lead-time associated with extensive post-press conversion.

One way to address these problems is to convert roll stock followed by cutting into sheets or blanks, which are then printed. Because the corners of the sheets can be used to register the stock with the printer, images can be printed on the stock with greater accuracy. Examples of prior art references that teach conversion of roll stock, then cutting followed by printing include U.S. Pat. No. 1,933,120 (Rife); U.S. Pat. No. 5,167,739 (Hutchinson et al.); U.S. Pat. No. 5,366,146 (Haan et al.); U.S. Pat. No. 2,134,057 (Potdevin) in which the roll stock is formed into bag tubes which are cut prior to printing; U.S. Pat. No. 6,811,527B2 (Andersson et al.) in which the roll stock is cut lengthwise and the entire surface coated prior to printing.

Another approach is conversion of sheet stock followed by printing, as in U.S. Pat. No. 4,668,211 (Lubotta et al.); U.S. Pat. No. 5,472,240 (Davies); U.S. Pat. No. 5,622,390 (Jenkins); U.S. Pat. No. 5,622,390 (Jenkins); U.S. Pat. No. 6,003,760 (Abercrombie); U.S. Pat. No. 6,129,389 (Younger); U.S. Pat. No. 6,248,049 (Scheggetman); and U.S. Pat. No. 6,290,634 (Lombardo et al.). However, by cutting the stock into sheets before printing, these approaches eliminate the storage and transportation advantages and cost savings associated with printing from roll stock.

Some prior art references teach subjecting roll stock to a series of continuous sequences or stations in which conversion operations are performed immediately before printing, which in turn is immediately followed by cutting of the stock for use. These references include U.S. Pat. No. 2,671,382 (Vogt); U.S. Pat. No. 4,349,346 (Bromberg). Such complete processing of printed pieces in a single sequence lacks flexibility and does not provide the speed and flexibility that are available when pre-converted roll stock is available on hand for printing and cutting on demand.

Other references teach use of tractor drive holes along the margins of the roll stock to guide placement of printing and conversion operations, such as U.S. Pat. No. 2,824,685 (Patton); U.S. Pat. No. 4,067,171 (Herbert et al.); U.S. Pat. No. 4,448,443 (Jones); U.S. Pat. No. 5,553,774 (Goodno); U.S. Pat. No. 6,290,634 (Lombardo et al.). In U.S. Pat. No. 2,150,016 (Wood), printing and holes are applied simultaneously, and the holes are used to guide cutting of blanks. In U.S. Pat. No. 4,726,802 (Volk, Jr.), printing and holes are applied simultaneously, and the holes are used to guide subsequent individualized or personalized printing. Such tractor holes spoil the side margins of the roll stock, and must either be removed, as by a tear-off arrangement, or the entire piece must be die cut or punched out from the roll stock.

The recent development of digital printing processes has enabled printed materials to be individualized or personalized using variable arrangements of text and graphic images, including digital photo images, stored on a computer database. This variable data can be moved electronically in the form of digital files that are read by a digital output device or press. A wide variety of personalized variable text and variable image data such as name, address, educational background, income level, hobbies and interests, previous purchases, images of homes in a geographic area, etc. is collected by businesses, educational, professional and other organizations for their own use. This data is often available for purchase by companies and organizations for use in marketing their products and services. Digital printing enables such stored personalized variable data to be combined with other databases, such as images of pets and various consumer products, to be culled and combined for selective printing to create unique, one of a kind printed pieces. Digital printing enables use of personalized variable data to print individualized pieces in runs as small as a single piece, or as large as tens of millions of unique pieces, each piece imprinted with text and images selected from a database for the purpose of appealing to the intended recipient.

For example, a marketing piece, such as a real estate advertising flier, can be customized with the name and address of the intended recipient, images of homes preselected to fit the recipient's marketing profile, as well as a personalized greeting and individually targeted message. A packaging piece such as a presentation folder or CD jacket, can be customized with the name of the organization and the presentation, as well as personalized variable data targeted to the audience or recipients. Graphic images may also be selected to appeal to a profile of an individual recipient based on stored information about the recipient's habits and personal preferences or the characteristics of the organization receiving the packaging piece. As another example, a school picture order form with an attached payment return envelope can be personalized so that each form is printed with the photo proof image(s) of a single, preselected student including the student's name and/or autograph, the name of the school, grade, teacher and other such variable data or any combination thereof. Use of personalized variable data digitally printed on such mailings has been shown to substantially increase orders.

However, personalized variable data print runs do not fit well into the conventional print-then-convert workflow sequence. Sophisticated conversion processes are cost prohibitive for these runs. In addition, where every digitally printed impression is unique, there are no print overruns available to compensate for waste which occurs from operator and/or equipment error, misalignment of perforations, glue or other post-press conversion processes on the stock. In a job run of personalized variable data orders, the sole remedy for spoilage is repeat of the entire process of printing followed by all of the post-press converting steps. Not infrequently, such a job run must be repeated several times in order to produce a complete, error-free run.

Accordingly, there is a need for a roll stock that is pre-press converted to include adhesives, coatings, perforations, embossing, scores, die cuts and the application of registration indicia for registration and alignment of an imaging device for subsequent printing as necessary, thus significantly reducing the number of post-press converting steps which substantially reduces production time and spoilage.

### SUMMARY OF THE INVENTION

The present invention provides a greatly improved printable roll stock having a continuous web with printable surfaces that include a plurality of spaced registration marks for reference in positioning complex converting operations and image printing and a process for forming such a pre-converted roll stock. The web has been pre-converted by application of registration marks, remoistenable and pressure sensitive co-adhesive compositions, coatings, perforations, scores, notches, die cuts and embossments. The combination of conversion operations forms a series of repeating templates on the continuous web. The templates receive personalized variable data in the form of text and images from an imaging device such as a press or digital printer. The stock may be pre-converted and printed to form a variety of printed pieces and packaging, including direct marketing, billing, self-mailers, return envelopes, reply cards, presentation folders, boxes and CD jackets. Once printed, the roll stock may be cut and folded to form self-mailing envelopes, fliers and return envelopes, reply cards, boxes, sleeves and the like and may be subjected to additional conversion operations such as the application of cellophane windows.

The invention further includes the method of providing a unique text and/or a unique image on each template of a plurality of repeating printable templates. Each of said templates has been previously formed on a roll of stock by the pre-conversion of selected areas of the stock. The method is achieved by selecting a database an image and/or text and printing said selected image and/or text on one of said plurality of templates. Further selecting of unique text and/or images followed by further printing of the selected unique text and/or unique images on the plurality of templates provides a plurality of templates, each of which contains a text and/or image which is unique from the text and/or image in every other template.

Various objects and advantages of this invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a diagrammatic perspective view of the prior art post-conversion method of processing roll stock by printing followed by conversion steps of perforating and cutting.

FIG. 2 is a diagrammatic perspective view of a roll of pre-converted stock in accordance with the present invention passing through a printer for printing of the pre-converted stock with variable data.

FIG. 3 is a top plan view of a self-mailer with a return envelope showing registration indicia and personalized variable data placement.

FIG. 4 is a bottom plan view of the mailer shown in FIG. 3.

FIG. 5 is a view similar to that shown in FIG. 3 and showing the first fold in an assembly sequence.

FIG. 6 is a view similar to that shown in FIGS. 4 and 5 and showing the second fold in an assembly sequence.

FIG. 7 is a view similar to that shown in FIG. 6 and showing the third fold in an assembly sequence.

FIG. 8 is a view similar to that shown in FIG. 7 and showing a final fold in an assembly sequence.

FIG. 9 is a perspective view of the self-mailer piece following folding and sealing and ready for mailing and containing a return envelope.

FIG. 10 is a combination view of the piece shown in FIGS. 3-9 showing the return mailing envelope being separated along the perforations from the opened piece, and the order form being separated along the perforations from the return envelope.

FIG. 11 is a perspective view of the completed order form being inserted into the return envelope.

FIG. 12 is a rear perspective view of the return envelope undergoing sealing.

FIG. 13 is a front perspective view of the sealed return order envelope.

FIG. 14 is a plan view of a photo proof mailer with return envelope.

FIG. 15 is a view similar to that shown in FIG. 14 and showing the envelope portion folded preparatory to adhesion to the co-adhesive glue strip.

FIG. 16 is a perspective view of the piece shown in FIGS. 14 and 15 and showing an envelope pouch adhered to the co-adhesive glue strip and a front cover folding toward the remoistenable glue strip preparatory to adhesion in covering relation to a zip strip and the envelope pouch.

FIG. 17 is a perspective view of the piece following folding and sealing and ready for mailing and containing a return envelope.

FIG. 18 is a perspective view of the piece showing the front cover unfolded to an open position and the return envelope in the process of tearing off at the perforations.

FIG. 19 is a perspective view of the return envelope completely separated along the perforations from the front cover.

FIG. 20 is a view similar to FIG. 19, showing the remoistenable glue strip folded over to seal the return envelope and the zip strip lifted for separation along the perforations.

FIG. 21 is a front perspective view of the sealed return order envelope.

FIG. 22 is a top plan view of a presentation folder.

FIG. 23 is a bottom plan view of the presentation folder shown in FIG. 22.

FIG. 24 is a flow diagram showing method steps in manufacturing from roll stock a marketing piece printed with variable data.

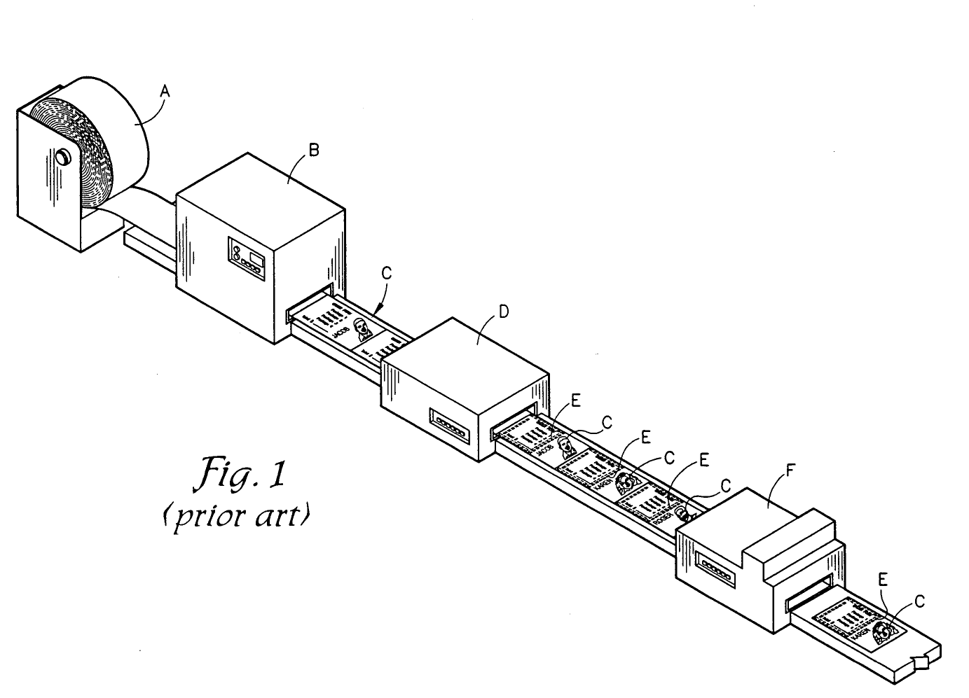

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

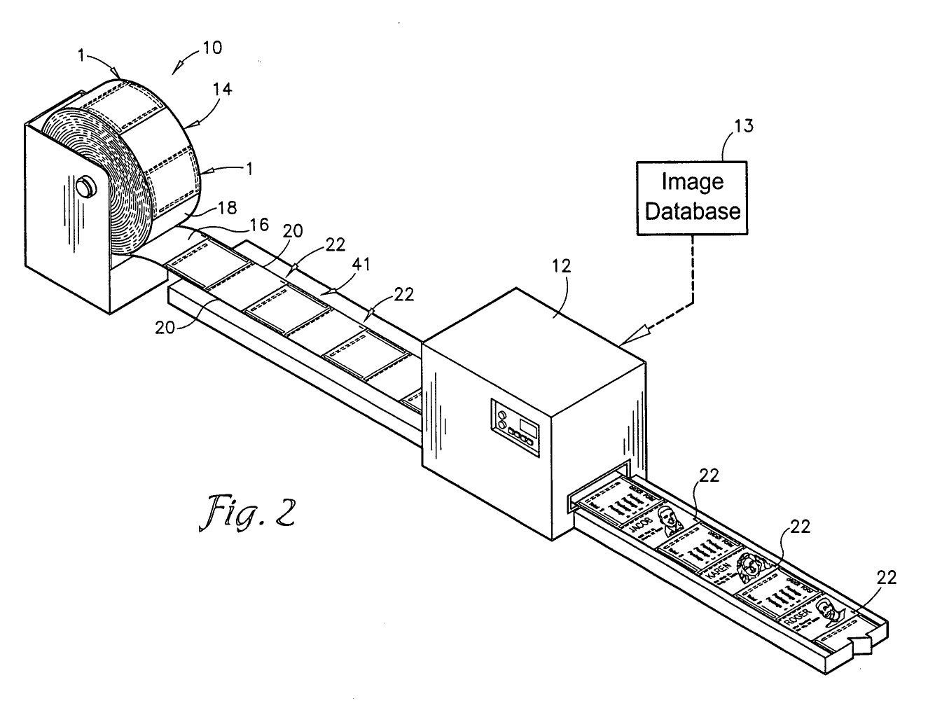

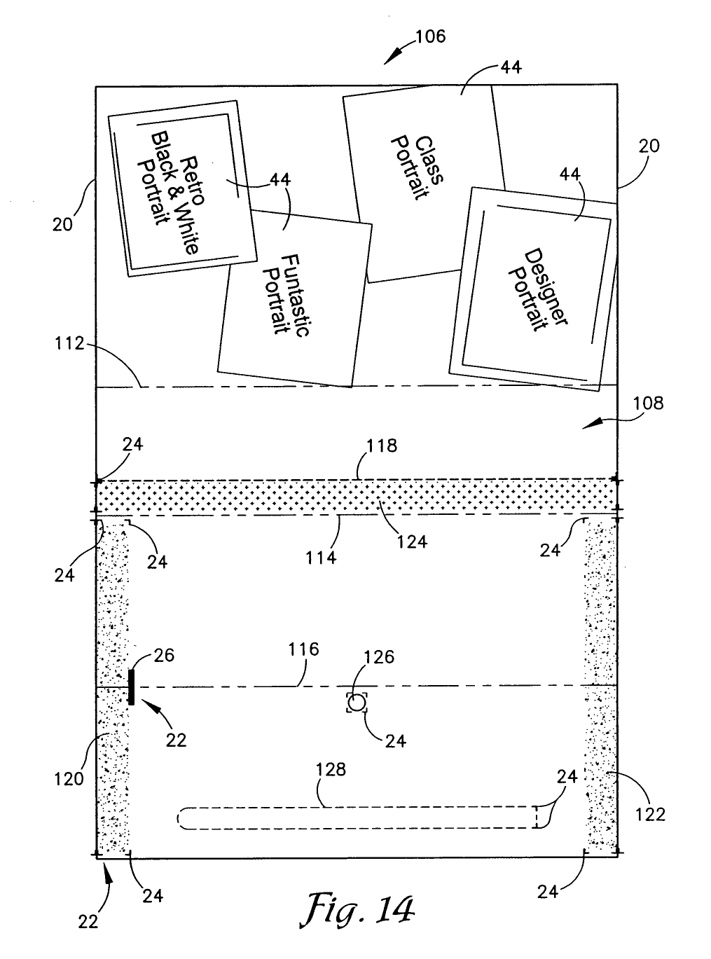

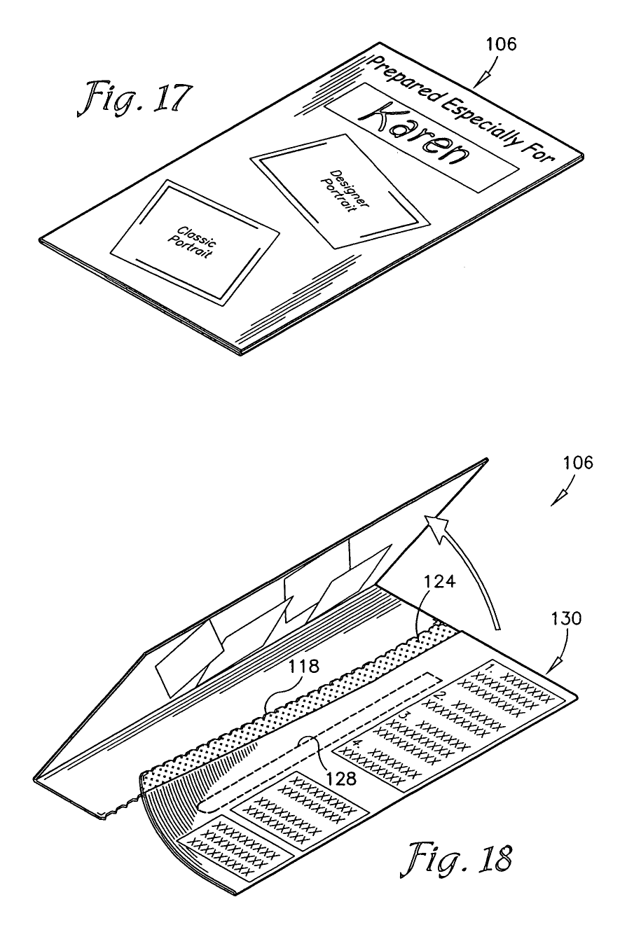

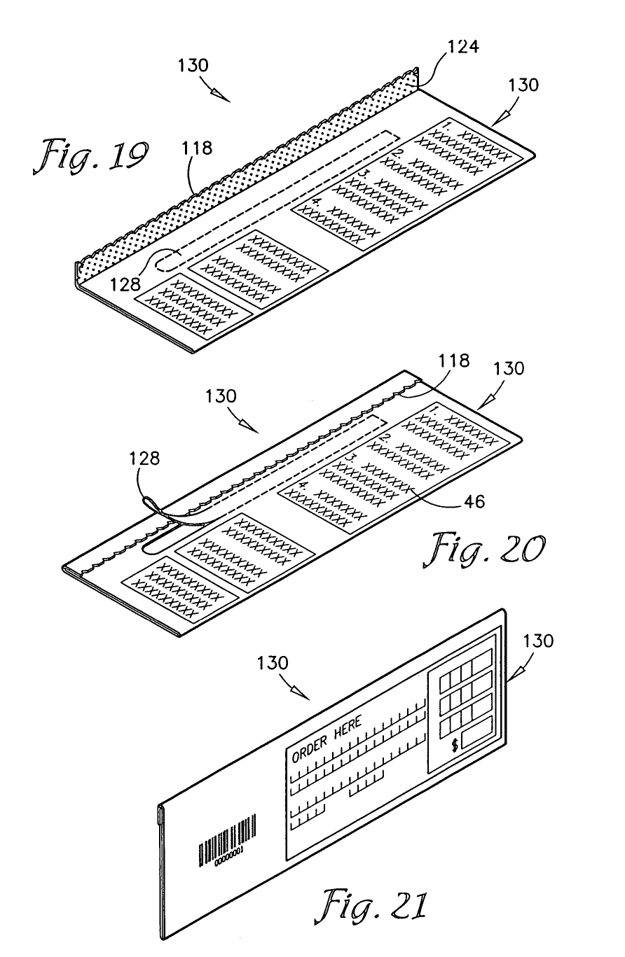

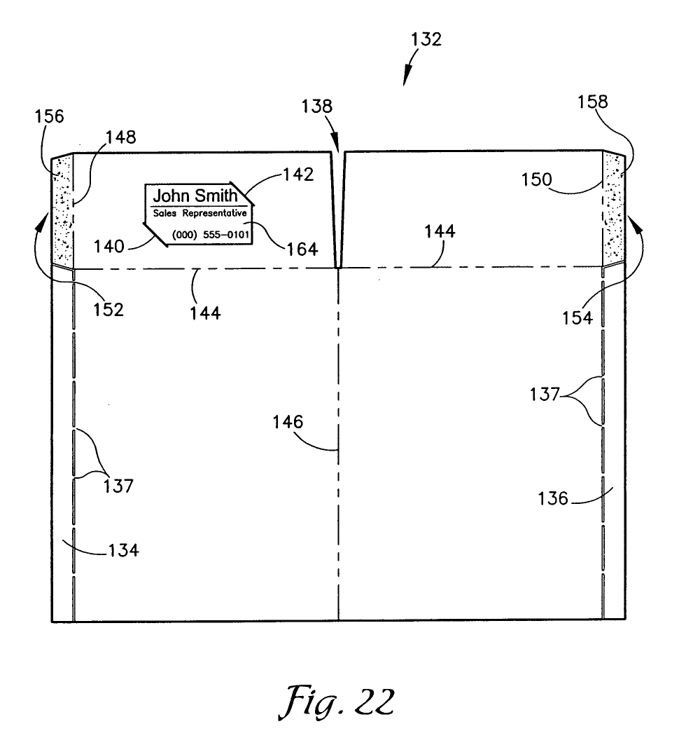

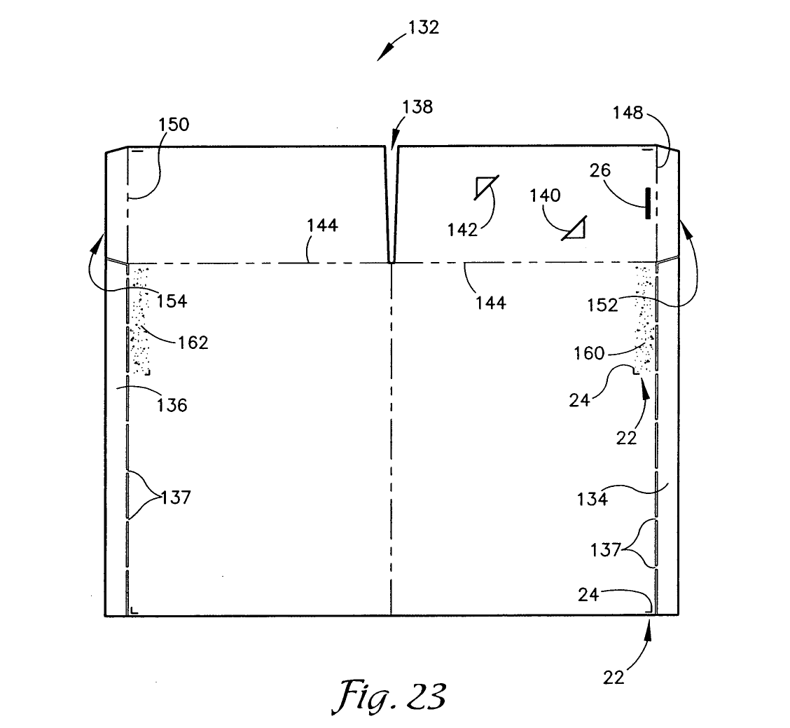

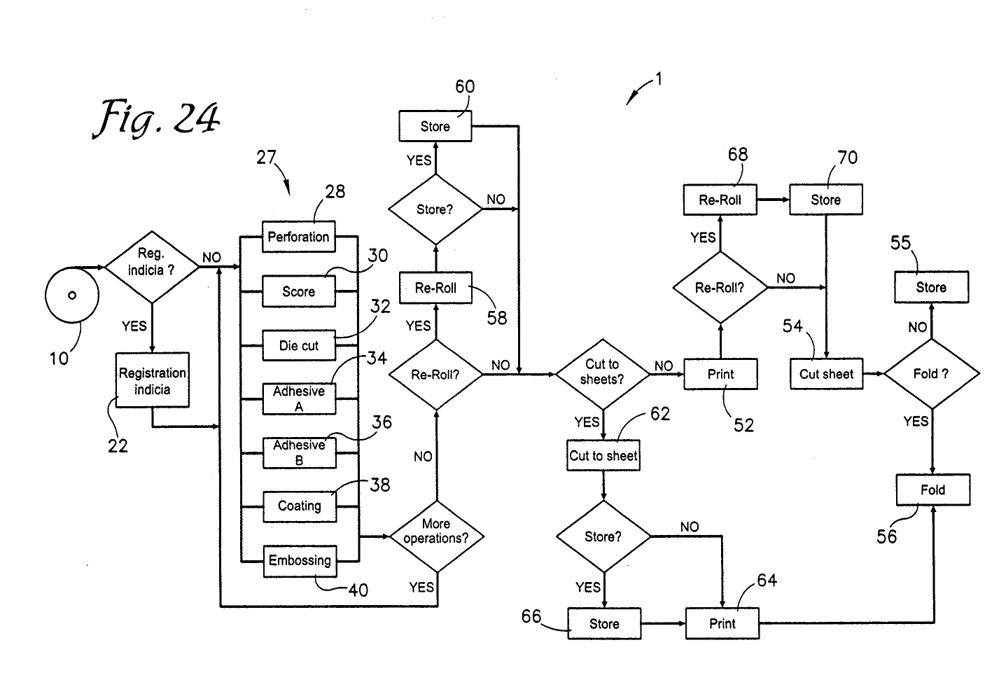

Referring now to the drawing figures, the reference numeral 1 refers to a process for pre-converting roll stock to thereby form return envelopes, packaging and the like and which embodies the present invention. A roll of printable stock 10 has been pre-treated or “pre-converted” by subjecting it to structural and/or material application processes prior to printing in accordance with the invention, and is depicted in FIG. 2 in an in-line arrangement with a printing press 12. The pre-converted stock 10 may be used to form a variety of printed mailing and packaging pieces such as self-mailers with detachable return envelopes (FIGS. 3-13); photo proof mailers (FIGS. 14-21); packaging, such as presentation folders (FIGS. 22-23) and the like.

The pre-converted roll stock 10 includes a continuous web 14 of a printable stock material, such as paper, wound on a core (not shown) to form a roll and having a first, normally upper or top surface 16 and a second, normally lower or bottom surface 18. The surfaces 16 and 18 are generally planar when unwound from the roll 10, and include a pair of elongated lateral or side margins or edges 20. The roll stock 10 may be of virtually any suitable width and length and may include a plurality of thicknesses, layers or plies of web stock 14, each of which may include any or all of the structures and features described herein. The web 14 may be formed of any printable material, such as paper, card stock, cardboard, synthetic resin fibers or film such as polyester, or any other material that is printable, rollable and that may be cut into sheets, banners or shaped pieces.

As best shown in FIGS. 2-4, the upper and lower surfaces 16 and 18 each include a series of registration or registry indicia or marks 22 for aligning the operations of a printing press 12 (FIG. 2) and/or converting equipment 27 (FIG. 24). The registry marks 22 include small, generally L-shaped or cross-shaped trim or tic marks 24 and larger, elongate rectangular bars or eye-marks 26 (FIG. 3). These marks 24 and 26 are generally applied to one or both surfaces 16 and 18 of the stock as may be preferred by printing using a conventional optically visible ink composition for reading by an optical reader associated with the printing and/or converting equipment. It is foreseen that the registry marks may include any readable marks or indicia, whether or not visible to the human eye, such as infra red or ultra violet readable ink, water marks, perforations, notches, indentations or depressions or raised areas that are machine readable or otherwise capable of automatic recognition. The registry indicia or marks 22 may also have any appropriate shape such as a bar or line, triangle, quadrilateral, curvate, compound curvate or three dimensional shape or any combination thereof.

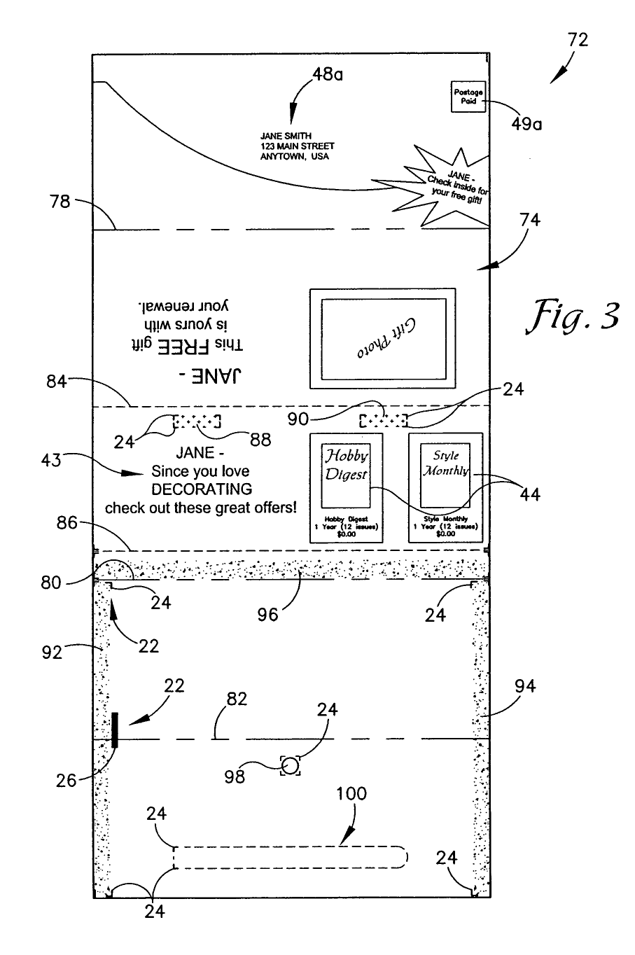

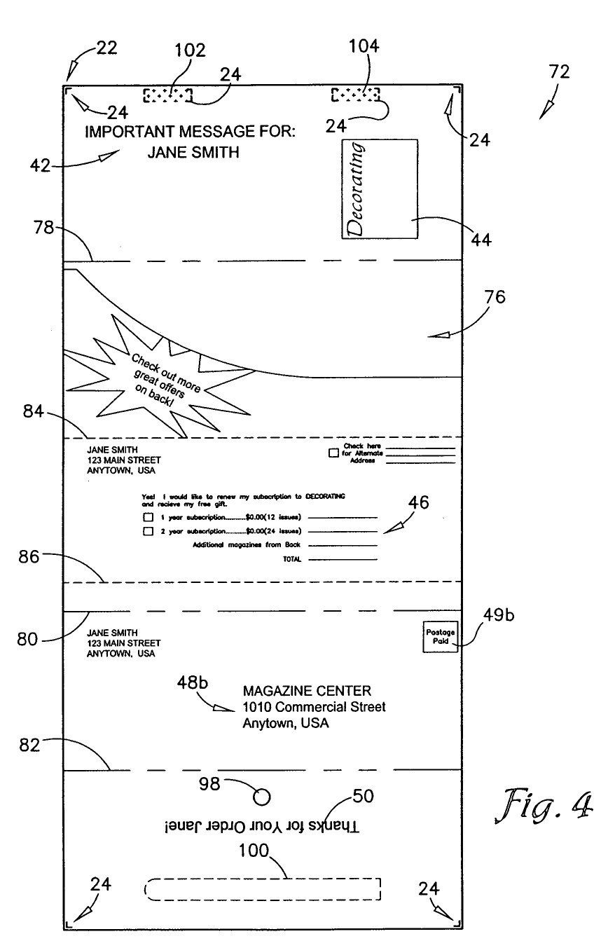

The tic marks 24 may be positioned singly or in multiples such as spaced pairs and are generally employed for marking a position for application of a pattern of an adhesive substance 34 or 36 (FIG. 24) or perforations 28, although they may also be employed for marking the position of die cuts 32, scores 30, coatings 38 and embossed areas 40. As shown in FIGS. 3 and 4, the eye-marks 26 are generally somewhat larger than the tic marks 24, although the two marks may be sized to the same scale, and they may also be positioned singly or in multiples.

The eye marks 26 are positioned at spaced intervals to repeat along the web 14 and are generally employed for locating a series of printed images 42, 43, 44, 46, 48a-b, 49a-b and 50 (FIGS. 3-4). The eye marks 26 are depicted as oriented lengthwise on the web 14 in generally adjacent, spaced relation to the side edges 20. They may also be positioned in transverse, angled or any other relation to the edges 20 and they may be positioned at any location on or between the edges 20 of the web 14.

It is foreseen that the tic marks 24 may also be used for marking the position of the images 42-50 and that the eye-marks 26 may be used for marking the application of the various conversion and/or printing processes. Either or both of the tick and eye marks 24 and 26 may be employed for positioning a cutting, sheeting and/or folding operation. Alternatively, a single set of registry marks 22, either tic marks 24 or eye marks 26, may serve to mark the positions of some or all of the processes used to produce a finished printed piece.

It is also foreseen that the registration indicia 22 may be omitted entirely or used in combination with a metering device or a computer memory chip. For example, a metering roller or other device may be employed to advance the roll stock 10 to a preset length in accordance with precalculated templates for placement of the printing and/or conversion operations. Alternatively, notches or other pre-print conversion operations, such as perforations may be used for registry of either a metering device, other conversion operations or the press 12. Still further alternatively, the topography of the conversion operations performed on the web 14 could be digitally stored for use by the press 12 in registering the printed images and data with a template 41 formed by the by the perforations, scores, die cuts, adhesives, coatings embossing or other pre-conversion operations that have been applied to the web 14.

The printing press 12 (FIG. 2) may include traditional printing equipment, such as, for example, a traditional offset press or it may be a flexographic or a digital press capable of storing variable data and images on a computer database for selection by a user. The digital printer 12 applies personalized, variable images from digitized computer files stored on an image database 13 in electronic communication with the printer 12. As best shown in FIGS. 3 and 4, a greeting text 42, advertising image(s) 44, order form 46, recipient address text block 48a and return address text block 48b, recipient postage 49a, return postage 49b, and a closing salutation or thank you text block 50 may all be selected for congruence with the information available about the identity and tastes of the intended recipient to create a unique or one-of-a-kind personalized digitally imaged piece.

Referring now to FIG. 24, a method or process 1 for pre-converting roll stock and forming return envelopes and packaging in accordance with the invention includes the steps of unwinding the roll stock 10, optionally applying registry indicia or marks 22, and then using conversion equipment or converters 27 to subject the web 14 to application of one or more pre-print conversion process such as perforations 28, scores 30, die cuts 32, an adhesive composition A, 34, an adhesive composition B, 36, coating compositions 38, and embossing 40.

As previously discussed, the registration indicia 22 may be printed or they may be applied using the conversion equipment 27, such as, for example perforations 28, notches 32 or embossments 40. The indicia 22 may also be omitted entirely. The adhesive compositions A and B 34 and 36 may include remoistenable adhesives, self-adhesives or co-adhesives, pressure sensitive adhesives, temperature actuated adhesives, or any other composition capable of adhering one portion of the piece to another or to a third item to be subsequently attached to the printed piece, such as, for example, a label, cellophane window, compact audio or video disc (CD) or payment card.

While certain exemplary pre-conversion processes conducted prior to printing of the web 14 have been described herein, those skilled in the art will appreciate that in the present invention any pre-conversion process may be performed on the stock prior to printing, including structural or shaping operations such as perforating, stamping, cutting (including, for example, so-called “cookie cutting”, notching, slitting, punching), scoring, embossing, or the like or the applications of materials to the web such as adhesives, coatings (including for example, scratch-off, scratch-and-sniff, colored or textured coatings), labels, cellophane windows, or the like. The pre-press conversion processes may also be performed singly or in any number, order and/or combination thereof.

The pre-converted stock may next be printed 52, preferably using personalized variable data retrieved from the image database 13 (FIG. 2) and applied as the web 14 is fed as a unit through a digital press 12 or other imaging device. The stock may next be cut into sheets 54 and stored 55 or it may be folded 56 to form mailers and/or packaging pieces. Alternatively, the pre-converted stock may be rerolled 58 for storage 60, or cut into sheets 62 for printing 64 or storage 66 or vice versa. The sheets may be cut to any preselected length or alternating pattern of lengths, such as may be used to form small, mailable pieces, longer posters or extremely long banners. Following printing 52, the stock may be sheeted 54 and/or rerolled 68 and/or stored 70. The stored stock 70 may cut into sheets 54 and/or subject to additional conversion steps (not shown), such as application or attachment of CDs, payment cards, cellophane windows, stamps, labels, magnetic strips, additional die cuts, or any other suitable post-print conversion process.

An exemplary self-mailer 72 including a return envelope is depicted in FIGS. 3-13 to include a front side 74 (FIG. 3) and a reverse or back side 76 (FIG. 4). The front side 74 includes registration indicia 22, including tic marks 24 and eye marks 26 for positioning of a series of conversion operations, as well as for positioning a cutter for severing the piece 72 from the web 14. The mailer 72 is converted with structural applications including scores 78, 80 and 82 for folding of the piece therealong and two lines of perforations 84 and 86 for tearing separation of the envelope and order blank portions. The mailer 72 is also converted by application of materials including self adhesive or co-adhesive glue patterns or strips 88 and 90 for sealing the piece for postal mailing, elongated self-adhesive glue strips 92 and 94, positioned adjacent the side edges 20 of the piece 72 for forming a return envelope, and a remoistenable glue strip 96 for sealing the envelope following separation along the perforations 86. Additional structural operations include a die cut hole or punch out 98 and perforations and die cuts forming a zip strip 100. The mailer front side 74 also includes an eye mark 26, located for correct positioning of the printed images 42-50 within the template formed by the various conversion operations.

The second, reverse or back side 76 of the mailer 72 (FIG. 4) includes tic marks 24 for positioning of a pair of co-adhesive glue strips 102 and 104. It is also foreseen that tic marks 24 for positioning any of the pre-press conversion operations described for the mailer front side 74 could alternatively or additionally be employed on the reverse side 76, and that the eye marks 26 could similarly be employed on the reverse side 76.

The roll stock 10 is first pre-converted, then printed, cut to predetermined lengths, and assembled into a finished self-mailer piece 72 by folding. The self-mailer 72 is assembled in a sequence of folds depicted in FIGS. 5-9. The web 14 is first folded along the score line 82 in the direction of the arrow shown in FIG. 5 so that the adjacent first web sides 74 are brought into contact with each other. Because the score line 82 generally bisects the co-adhesive strips 92 and 94, each strip 92 and 94 is folded in half onto itself so that one half of each surface 92 or 94 adheres to the other half to form an envelope pouch 105 therebetween. Once the envelope 105 is formed, it will be observed that the die cut hole 98 is located for viewing the contents of the envelope 105 after it is sealed. While the hole 98 is depicted as generally circular, it may have any suitable configuration, or a plurality of holes may be provided.

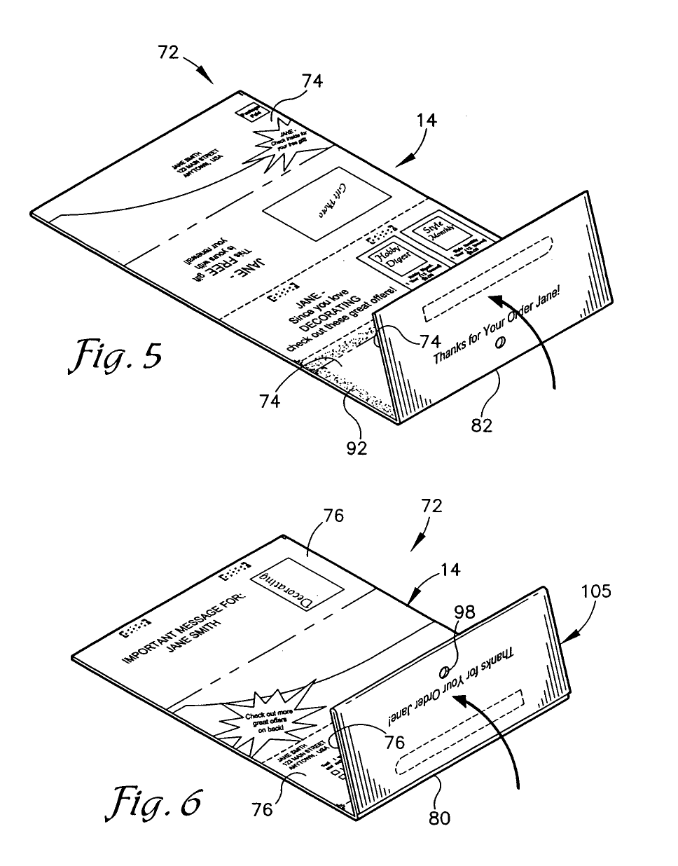

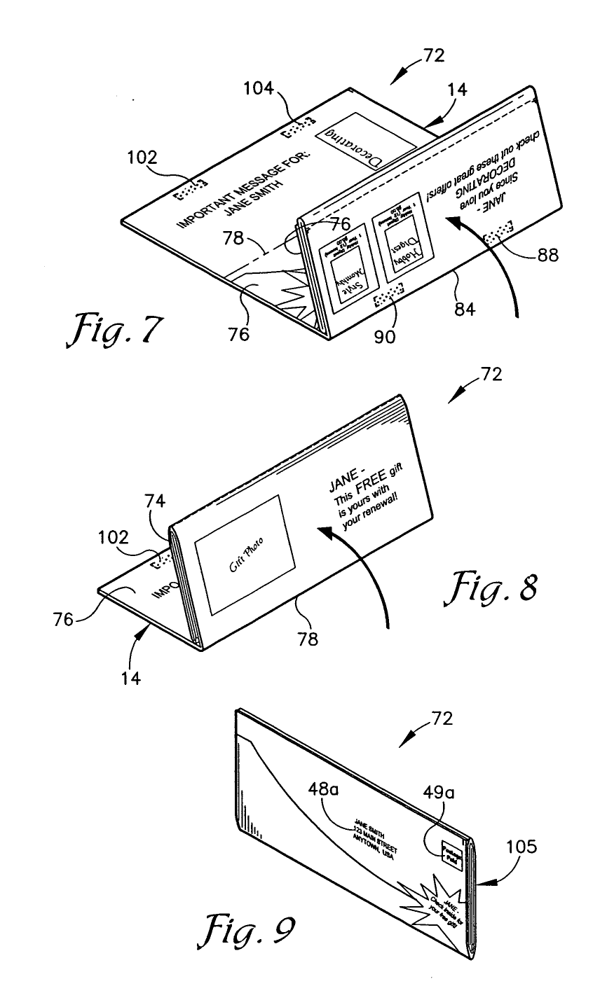

As shown in FIG. 6, the web 14 is next folded along the score line 80 so that the adjacent second web sides 76 are brought into contact with each other to form a Z-type fold. FIG. 7 depicts the third fold, in which the web 14 is next folded along the perforation line 84 so that the adjacent second web sides 76 are brought into contact with each other in a roll type fold. In the final fold, shown in FIG. 8, the web 14 is folded along the score line 78 to bring the adjacent second side 76 into contact with the now adjacent portion of the first side 74, completing the roll type fold. This final fold brings the co-adhesive strips 88 and 90 (FIGS. 3,7,8) into sealing contact with the co-adhesive strips 102 and 104, respectively, to form a self-mailer 72 with an embedded return envelope 105 shown in FIG. 9, with the printed recipient's name and address 48a and postage 49a correctly positioned for mailing.

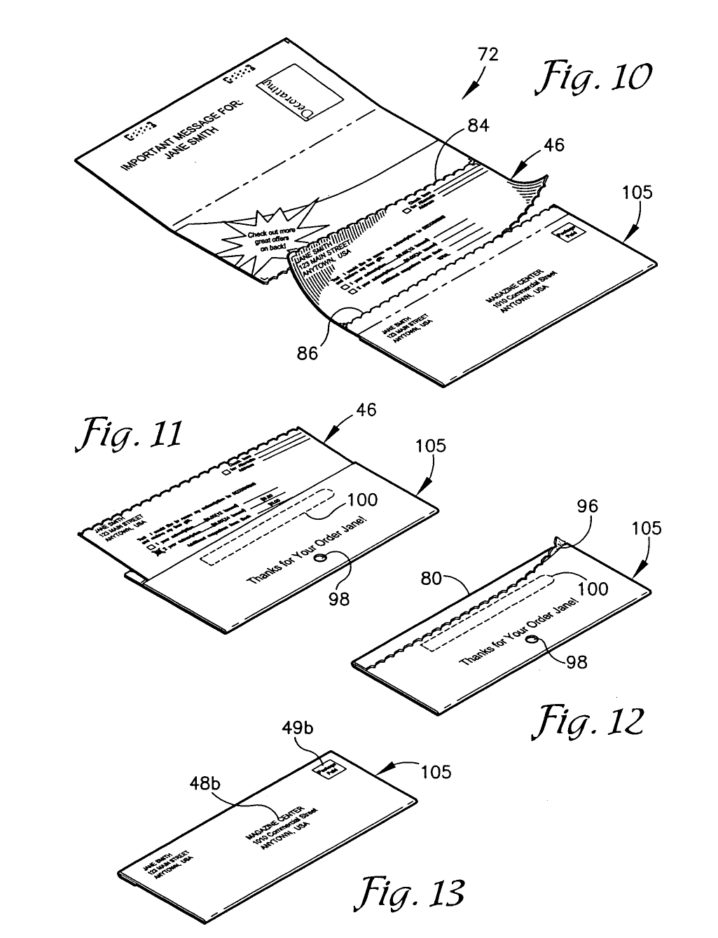

A recipient of the self-mailer 72 easily breaks or tears any such seal and separates the co-adhesive strips using a finger, letter opener or similar device. Once the personalized text and images 42, 43 and 44 and order form 46 (FIGS. 3-4) have been perused by the recipient, the return mailing envelope 105 and order form 46 may be separated from the opened piece by tearing along the perforations 86 and 84 as shown in FIG. 10. The completed order form 46 is next inserted into the envelope 105, (FIG. 11) which is sealed by moistening the remoistenable glue strip 96 and folding along the score line 80 (FIG. 12). Folding brings the glue strip 96 into sealing relation with the second side of the envelope 105 to form a sealed return order envelope 105 as shown in FIG. 13.

Upon receipt of the return envelope 105 by the vendor, the hole 98 is employed to view the contents of the sealed envelope pouch 105. If an order form 46 is viewable, the vendor lifts the tab end of the zip strip 100 and pulls to tear-away the strip and create an entry void into the envelope 105 for removal of the order form 46

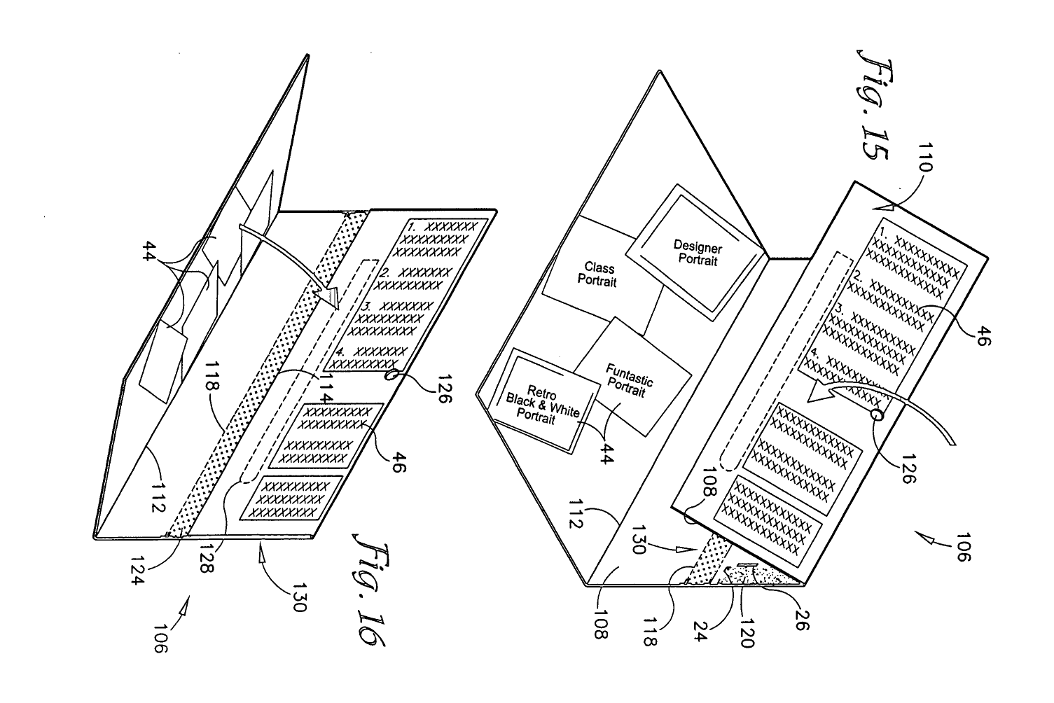

An exemplary photo proof mailer 106 including a return envelope is depicted in FIGS. 14-21 to include a first or inner side 108 (FIG. 14) and an opposite second or outer side 110 (FIG. 15). Each side includes registration indicia 22, including tic marks 24 and eye marks 26 for positioning a series of scores 112, 114 and 116 for folding the piece, a line of perforations 118 for separation of the envelope portion from the remainder of the piece, co-adhesive glue strips 120 and 122 for sealing the sides of the envelope pouch, remoistenable glue strip 124 for sealing the envelope once it has been separated along the perforations 118, for positioning a die cut hole or punch 126, perforations and die cuts for a zip strip 128, as well as for positioning a cutter for cutting the piece to length. An eye mark 26 is located for positioning of the printed images 44 and instruction text 46 (FIG. 21) within the pre-print conversion template. The co-adhesive strips 120 and 122 are applied in generally parallel relation to each other adjacent the side edges 20 of a preselected portion of the web. The score lines 112. 114 and 116 are applied in transverse or perpendicular relation to the side edges 20. The co-adhesive strips 120 and 122 and score line 116 cooperatively form the sides of an envelope pouch 130 when the web 14 is folded along the score line 116 in the direction of the arrow shown in FIG. 15 so that the inner web sides 108 are brought into contact with each other. The die cut hole 126 may be of any shape and may be positioned in any convenient location that is suitable for viewing the contents of the envelope pouch 130 when it is sealed by folding in half of each glue strip 120 and 122 and approximating the surfaces of the respective strips so that one half of each surface 120 or 122 adheres to the other half.

The tic marks 24 also serve to direct the application of a remoistenable glue strip 124 and perforations 118. The remoistenable glue strip 124 is used in sealing the envelope pouch 130 when the pouch is disengaged from the remainder of the finished piece by tearing along the perforations 118 and folding over, as shown in FIGS. 18-21.

An exemplary presentation folder 132 is depicted in FIGS. 22 and 23 to include registration indicia 22 including tic marks 24 and eye marks 26 for positioning of the conversion and printing operations. The shape of the folder is defined by die cuts which define tear-away portions 134 and 136, which remain attached by narrow pieces of stock or nicks 137, and a die cut slot or gutter 138. Business card slits 140 and 142 are also die cut. The gutter 138 and slits 140 and 142 may be generally straight as depicted in FIG. 22, or they may be of angled, curvate or any other suitable configuration or combination thereof.

The folder 132 also includes scores 144, 146, 148 and 150 for horizontal and vertical folding and to fold the tabs 152 and 154. The tabs 152 and 154 each include a co-adhesive coating strip 156 and 158. A second set of co-adhesive strips 160 and 162 is provided on the reverse or inside of the folder 132 as shown in FIG. 23. These strips 160 and 162 are positioned below the tabs 152 and 154 and inboard of the respective tear-away strips 134 and 136. The roll stock 10 from which the presentation folder 132 is constructed is first pre-converted, then printed, cut to predetermined lengths, and assembled by folding. Because the roll stock 10 is pre-converted, short runs consisting of small numbers of folders 132 may be custom printed economically and on demand using personalized variable data.

The presentation folder 132 is assembled by breaking the nicks 137 and removing the tear-away portions 134 and 136. The exposed tabs 152 and 154 are folded inwardly along the score lines 148 and 150 and the tabbed portion of the piece is then folded along horizontal score line 144 toward the untabbed portion of the piece until the tab co-adhesive strips 156 and 158 are brought into sealing contact with the co-adhesive strips 160 and 162 on the inside of the folder 132. The piece is next folded along the longitudinal score line 146 to form a presentation folder of conventional configuration and containing one or more pockets for storage of additional printed materials. A business card 164 may be inserted into the slits 140 and 142 now positioned on the front surface of the pocket defined by tab 152 and slot 138.

Pre-converting of the roll stock 10 by application of registration indicia, perforations, scores, die cuts, adhesives and other coatings and embossing as described serves to reduce the necessary post-press conversion steps. The pre-converted stock may be stored for use on demand and, in preferred embodiments, the sole remaining post-press conversion operations would be cutting of the stock into sheets 54 and folding 56 into the finished printed piece. Such reduction in post-conversion steps correspondingly shortens the production cycle and reduces post-press labor and overall waste. Advantageously, the pre-converted roll stock and method of the invention enable precise registry and alignment of an imaging device with pre-converted templates 41 which receive the images to produce unique individual printed pieces using personalized variable data stored on an image database 13 without costly spoilage and repeats.

It is to be understood that while certain forms of the present invention have been illustrated and described herein, it is not to be limited to the specific forms or arrangement of parts described and shown.

Having described the preferred embodiments of the present invention, the following is claimed as new and desired to be secured by Letters Patent:

1. A roll of pre-converted stock, the roll presenting a continuous web having at least one printable surface for receiving images thereon and comprising:
a. a plurality of repeating structural conversions and/or material application conversions;
b. said conversions positioned at selected locations along said web; and
c. a sequence of templates formed on said printable surface by said conversions to receive images, said images printed subsequent to said conversions for producing a plurality of functionally similar printed pieces with custom printed images.

2. The roll of pre-converted stock as set forth in claim 1, wherein said structural conversions include at least one of perforations, scores, die cuts and/or embossment.

3. The roll of pre-converted stock as set forth in claim 1, wherein said material application conversions include application of a layer of at least one of an adhesive substance and/or a coating composition.

4. The roll of pre-converted stock as set forth in claim 3, wherein said coating composition includes at least one of scratch-off coatings, colored coatings and/or texturized coatings.

5. The roll of pre-converted stock as set forth in claim 3, wherein:
a. said web has a reverse surface in opposed relation to said printable surface; and
b. selected ones of said conversions are positioned at selected locations on said reverse surface.

6. The roll of pre-converted stock as set forth in claim 1, wherein a plurality of images are stored in a database in electronic communication with a printer, and wherein:
a. selected ones of said images are printed on said printable surface.

7. The roll of pre-converted stock as set forth in claim 6, wherein said images include text and/or graphic images.

8. The roll of pre-converted stock as set forth in claim 6, wherein:
a. a unique image is printed on each template of said sequence of said templates.

9. The roll of pre-converted stock as set forth in claim 1 wherein said web is re-rolled subsequent to said conversion and prior to printing said image.

10. A roll of pre-converted stock, the roll including a continuous web presenting at least one printable surface for receiving images thereon and comprising:
a. a plurality of registration indicia in repeating patterns spaced along said web for use in positioning conversions and/or printing on said web;
b. a plurality of repeating structural conversions and/or material application conversions positioned at selected locations on said web in spatial relation to said registration indicia; and
c. a sequence of templates formed on said printable surface by said conversions to receive images printed on said printable surface in spatial relation to said registration indicia and subsequent to said conversion.

11. The roll of pre-converted stock as set forth in claim 10, wherein said registration indicia include at least one of printed marks, embossments, die cuts, notches, scores and/or perforations.

12. The roll of pre-converted stock as set forth in claim 11, wherein:
a. said printed marks are used in positioning a cutter for cutting said pre-converted printed web into sheets to form a plurality of functionally similar printed pieces.

13. The roll of pre-converted stock as set forth in claim 10 wherein said conversion includes at least one of perforations, scores, die cuts, embossment, a layer of an adhesive substance and/or a layer of a coating composition.

14. The roll of pre-converted stock as set forth in claim 13, wherein die cutting further includes notching of said stock.

15. The roll of pre-converted stock as set forth in claim 10, wherein a plurality of images are stored in a database in electronic communication with a printer, and wherein:
a. selected ones of said images are printed on said printable surface.

16. The roll of pre-converted stock as set forth in claim 15, wherein said images include text and/or graphic images.

17. The roll of pre-converted stock as set forth in claim 16, wherein:
a. a unique image is printed on each template of said sequence of said templates.

18. A roll of pre-converted stock, the roll presenting a continuous web having at least one printable surface for receiving images thereon and comprising:
a. a plurality of registration indicia in repeating patterns spaced along said web for use in positioning conversions and/or printing on said web;
b. a plurality of repeating structural conversions and/or material application conversions positioned at selected locations on said web in spatial relation to said registration indicia; and
c. a sequence of templates formed on said printable surface by said conversions to receive images printed on said printable surface in spatial relation to said templates and subsequent to said conversion.

19. The roll of pre-converted stock as set forth in claim 18, wherein said registration indicia include at least one of printed marks, embossments, die cuts, notches, scores and/or perforations.

20. The roll of pre-converted stock as set forth in claim 19, wherein:
a. said pre-converted stock is cut into sheets to form said plurality of functionally similar printed pieces; and
a. said printed marks are used in positioning a cutter for cutting said pre-converted printed web into sheets.

21. The roll of pre-converted stock as set forth in claim 19, wherein a plurality of images are stored in a database in electronic communication with a printer, and wherein:
a. said pre-converted stock is cut into sheets to form a plurality of functionally similar printed pieces; and
b. selected ones of said stored images are selected for printing on said printable surface to form individualized printed pieces.

22. A roll of pre-converted stock, the roll presenting a continuous web having at least one printable surface for receiving a plurality of images thereon and comprising:
a. a first plurality of spaced registration indicia positioned in repeating relation along said printable surface for use in positioning conversions on said web;
b. a second plurality of spaced registration indicia positioned in repeating relation along said printable surface for use in positioning printing on said web;
c. a plurality of repeating structural conversions and/or material application conversions positioned at selected locations on said web surface in spatial relation to said first registration indicia to form printable templates;
d. a plurality of images and/or text printed in said templates on said printable surface in spatial relation to said second registration indicia and subsequent to said conversion;
e. wherein said images and/or text are selected from a database in electronic communication with a printer;
f. said pre-converted stock is cut into sheets after being printed to form said plurality of functionally similar printed pieces; and
g. said images and said text are selected for individualizing said printed pieces.

23. A method of pre-converting a roll of printable stock for subsequent cutting into sheets to form a plurality of functionally similar printed pieces with custom printed images, the stock presenting a continuous web having at least one printable surface, the method comprising the steps of:
a. unrolling a portion of said web;
b. applying a plurality of spaced registration indicia to said web;
c. aligning a converter with selected registration marks and converting selected areas along said web; and
d. rerolling said converted web into a roll for subsequent printing of said printable surface.

24. The method of pre-converting a roll of printable stock as set forth in claim 23, wherein said converting step includes at least one of: applying a layer of an adhesive composition to said web; applying of a layer of a coating to said web; scoring said printable surface; perforating said web; embossing areas of said web; die cutting said web; and/or combinations thereof.

25. The method of pre-converting a roll of printable stock as set forth in claim 23 and including the step of:
a. unrolling at least a portion of said converted web; and
b. sequentially printing images and/or text on said portion of said converted web.

26. A method of pre-converting a roll of printable stock for subsequent cutting to form a plurality of functionally similar printed pieces with custom printed images, the stock presenting a continuous web having a first surface and a second surface, said method comprising the steps of:
a. unrolling a portion of said web;
b. applying a plurality of spaced registration indicia to said first surface of said web;
c. applying a plurality of spaced registration indicia to said second surface of said web;
d. aligning conversion equipment with selected registration marks and converting selected areas of said web to form a plurality of repeating printable templates;
e. rerolling said web to form a pre-converted roll of stock;
f. subsequently unrolling at least a portion of said web from said pre-converted roll of stock; and
g. aligning a printer with said registration marks and printing in said templates on said first and second surfaces of said web.

27. The method of pre-converting a roll of printable stock as set forth in claim 26, further including the step of:
a. aligning a cutter with said registration marks and cutting said web to cut said web into a plurality of sheets in accordance with said templates to form said printed pieces.

28. The method of pre-converting a roll of printable stock as set forth in claim 27, further including the step of;
a. aligning a folder with selected templates and folding said sheets in accordance with said templates.

29. The method of pre-converting a roll of printable stock as set forth in claim 26, further including the step of:
a. calling up a first unique text and/or image from a database;
b. applying said first unique text and/or image to a first of said plurality of repeating printable templates; and
c. calling up a second unique text and/or image from said database;
d. applying said second unique text and/or image to a second of said plurality of repeating printable templates, wherein each of said plurality of repeating printable templates is imprinted with a unique text and/or image.

30. The roll of pre-converted stock as set forth in claim 6, wherein:
a. each of said selected ones of said images is unique, resulting in a unique image on each template.

31. The roll of pre-converted stock as set forth in claim 15, wherein:
a. each of said selected ones of said images is unique, resulting in a unique image on each template.
